(19) United States
(12) Patent Application Publication
(10) Pub. No.: US 2004/0172339 A1
(43) Pub. Date: Sep. 2, 2004

(54) Point of sale terminal

(76) Inventors: W. Martin Snelgrove, Toronto (CA); Michael Stumm, Toronto (CA); Everitt Long, Toronto (CA)

Correspondence Address: JERRY UMBRO, 14 SOMBERS DRIVE, RHINEBECK, NY, 12572

(21) Appl. No.: 10/380,910

(22) PCT Filed: Sep. 20, 2001
(86) PCT No.: PCT/CA01/01345

(30) Foreign Application Priority Data
Sep. 20, 2000 (US) 60234169
Sep. 5, 2001 (CA) 2356716

(51) Int. Cl. G06F 17/60

(52) U.S. Cl. 705/26; 705/35

(57) ABSTRACT

A financial transaction system operable to manage purchases of at least one of goods and services, comprising a customer identifier that is operable to uniquely identify an account to which the purchases are being charged; a financial services provider operable to at least one of debit and credit the account to which the purchases are being charged; a plurality of point-of-sale (POS) terminals in communication with the financial services provider via an intermediary node, where the point of sale terminals are operable to gather purchase information, customer identification and authorization information, and display information provided from a financial services provider; and a plurality of software agents distributed within the financial transaction system, operable to negotiate rules and behaviors for the purchase of goods and services.

### FIELD OF THE INVENTION

The present invention relates to the field of point of sale terminals. More specifically, the present invention relates to a wireless point of sale terminal using a distributed software architecture and software agents to provide customized transactions.

### BACKGROUND OF THE INVENTION

Point of sale (POS) terminals are common in the retail environment. Most modern POS terminals include a cash register, bar code scanner and/or other input device, a display screen and a card reader device to handle debit and credit card transactions. Typically the POS terminal requires a modem and a telephone line to connect to an outside financial services provider, such as a bank, acquirer agency or credit card company to approve credit card or debit card transactions.

When a retail clerk swipes a credit or debit card, the customer's account number and purchase amount are transmitted to the financial services provider. The magnetic stripe on the back of the card stores relevant information such as the financial institution, account number and expiry date according to ISO standard 7811. The financial services provider checks its own records to see if the customer's account has sufficient funds or credit to cover the cost of the purchase.

Presently, most POS terminals employ no better than a 14.4 kbaud modem which typically adds at least eight seconds to the time required to complete a transaction, giving customers a period of tension about the outcome. Each POS terminal requires its own telephone line and the setup generally prevents flexibility for retailers who wish to deploy extra POS terminals during peak periods or at specific locations in the store. The functionality of conventional POS terminals is limited to authorizing/declining transactions, and provides little in the way of customization.

Authorization security in these such transactions is also relatively limited For the customer, debit card security comes from inputting a PIN number for verification with the financial services provider. For credit card purchases, a signature is typically required when making a purchase in person. However, signatures provide security only after the fact—a customer can refuse to pay for a purchase when there is no receipt with a signature—but this arrangement does not protect the customer before his or her bill is received (a customer's credit limit can be exceeded unexpectedly), and creates aggravation for the customer. Additionally, the retailer will suffer an economic loss if a valid signature was not obtained and/or confirmed.

More advanced security systems, such as the use of biometric devices, are known but are not widely implemented due to limitations of computational and bandwidth resources in POS terminals. Furthermore, it is difficult to implement these newer systems and integrate them with existing legacy equipment.

For the retailer, while debit purchases are reasonably secure, credit card purchases are typically secure only against insufficient funds and not against fraud, etc. These problems are even worse when dealing with online transactions such as e-commerce activities over the Internet. Customers are often leery to give out their credit card numbers over the Internet and retailers can stand to lose revenue if a customer falsely claims fraudulent use of his or her account number, typically referred to as repudiation.

It is therefore desired to have a system, apparatus and method to provide financial transactions that are rapid, customizable, and secure.

### SUMMARY OF THE INVENTION

It is an object of the present invention to provide a novel system, apparatus and method of performing financial transactions and the like which obviates or mitigates at least one of the above-identified disadvantages of the prior art.

In an embodiment of the invention, there is provided a financial transaction system operable to manage purchases of at least one of goods and services, comprising:

a customer identifier that is operable to uniquely identify an account to which the purchases are being charged;

a financial services provider operable to provide and maintain at least one of a debit and credit account to which the purchases are being charged;

a plurality of point-of-sale (POS) terminals in communication with the financial services provider via an intermediary node, where the point of sale terminals are operable to gather purchase information, customer identification and authorization information, and display information provided from a financial services provider, and

a plurality of software agents distributed within the financial transaction system, each software agent operable to negotiate rules and behaviors for the purchase of goods and services.

In another embodiment of the invention, there is provided a point of sale terminal operable to enact sales of at least one of goods and services to a customer, involving a financial services provider, comprising:

input means to collect purchase information for the sales of at least one of goods and services;

input means to collect customer account information from the customer purchasing the at least one of goods and services;

communication means to transmit the purchase information and the customer account information to a financial services provider via an intermediary node and to receive info on and authorization from the financial services provider,

processing means;

input means to collect authorization from the customer, and

display means to display instructions and results of the sale of at least one of goods and services to a customer.

In another embodiment of the invention, there is provided a method for enacting a purchase of at least one of goods and services between a customer and a retailer involving a financial services provider comprising:

gathering information about the purchase of at least one of goods and services;

gathering information about customer making the purchase of at least one of goods and services;

retrieving software agents that are relevant to the purchase of at least one of goods and services;

negotiating rules and behaviors for the purchase of at least one of goods and services between the software agents;

enacting the rules and behaviors for the purchase of at least one of goods and services;

gathering authorizations from the customer, retailer and financial services provider for the purchase of at least one of goods and services;

completing the purchase of at least one of goods and services; and

generating records of the purchase of at least one of goods and services.

The invention relates to a financial transaction system consisting of POS terminals connected to a financial services provider such as a credit card agency or bank via an intermediary base station. The POS terminal combines an always-on high-speed modem (typically wireless) and the terminal contains various interfaces to connect with telephones, computer LANs, and other devices. The POS terminal is customized with the addition of card-swipe and smart-card readers and a cash-register interface, and perhaps with other hardware such as a camera, display monitor, fingerprint scanner, speaker phone or built-in telephone handset. Utilizing distributed software agents with the terminal, customizable rules and behaviors for the transaction are possible. Each party involved in the transaction (the customer, retailer, financial services provider, etc) has an agent with its own customized rules and behaviors. These agents negotiate and then enact the rules and behaviors of the transaction.

### BRIEF DESCRIPTION OF THE DRAWINGS

Preferred embodiments of the present invention will now be described, by way of example only, with reference to the attached Figures, wherein

FIG. 1 shows a diagram of a network in accordance with an embodiment of the invention;

FIG. 2 shows a diagram of a POS terminal for a retail environment in accordance with an embodiment of the invention;

FIG. 3 shows a diagram of an intermediary base station in accordance with an embodiment of the invention;

FIG. 4 shows a diagram of a software negotiation in accordance with an embodiment of the invention;

FIG. 5 shows a flowchart of a method in accordance with an embodiment of the invention;

FIG. 6 shows a flowchart of a method of negotiating between software agents in accordance with an aspect of the invention;

FIG. 7 shows a diagram of another point of sale terminal for a residential environment in accordance with another embodiment of the invention;

FIG. 8 shows a flowchart of a method in accordance with another embodiment of the invention; and

FIG. 9 shows a diagram of a network in accordance with another embodiment of the invention.

### DETAILED DESCRIPTION OF THE INVENTION

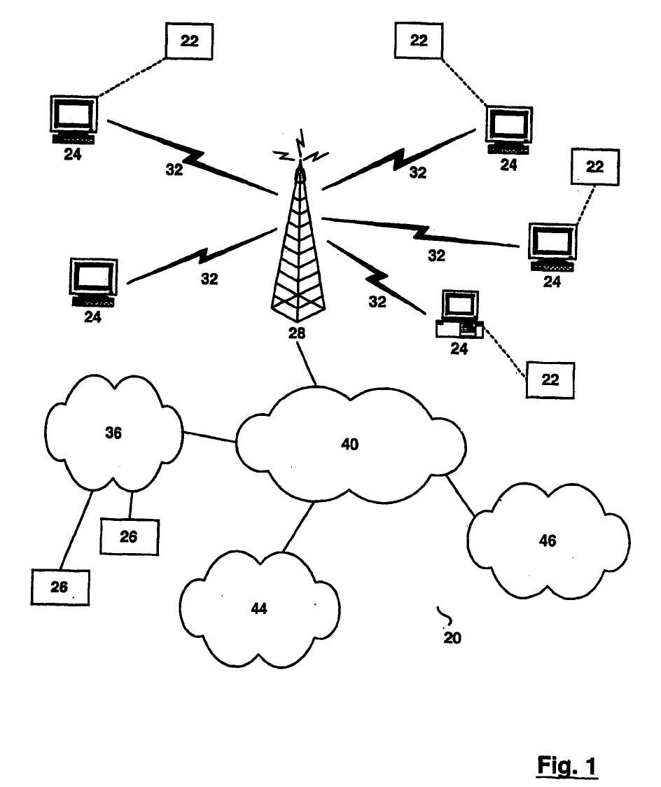

Referring now to FIG. 1, a financial transaction system is generally indicated at 20. Financial transaction system 20 includes at least one credit identifier 22 and a plurality of POS terminals 24. Credit identifier 22 is operable to uniquely identify an account 26 (stored within financial services provider 36, described below) which is to be debited or credited in the financial transaction. Account 26 can be any financial account which can be accessed to pay for purchases either through debit or credit means. In the present embodiment of the invention, credit identifier 22 is a credit card or debit car As known to those of skill in the art, credit cards and debit cards have account information printed on the front of the card and a magnetic strip on the back of the card which contains account information in an electronically readable format. The format of credit identifier 22 is not particularly limited and can also include smart cards, specially-programmed microchips (often implanted into key chains or the like), or any other secure means to identify account 26. Other formats of credit identifier 22 will occur to those of skill in the art.

POS terminal 24 is operable to receive account 26 information from credit identifier 22 and transmit this account 26 information to an intermediary node, such as a base station 28 across a communications link 32. In turn, base station 28 is connected to a financial services provider 36. Financial services provider 36 can include the servers, networks and databases used by banking institutions, credit card companies, acquirer agencies and other parties that are involved in the financial aspects of the transaction. As known to those of skill in the art, the hardware and software configurations of financial services provider 36 are not particularly limited and can vary considerably in their implementation. Financial services provider 36 can include the systems of multiple institutions that are operable to exchange information between each other.

The connection between base station 28 and financial services provider 36 is provided by backhaul 40, which can effected be across many diverse networks such as the Internet, private data networks, the PSIN, and private leased-line networks. Also connected to backhaul 40 are retailer systems 44, which can include ERP systems, customer loyalty databases, etc. that handle records of the retailer, and third-party systems 46 that handle records of other parties involved with any non-financial aspects of the transaction. As known to those of skill in the art, the hardware and software configurations of retail systems 44 and third-party systems 46 are not particularly limited and can vary considerably in their implementation. Retail systems 44 and third-party systems 46 can include the systems of multiple institutions that are operable to exchange information between each other.

In the illustrated embodiment, communications link 32 is established between base station 28 and each POS terminal 24 via radio. Communications link 32 can carry voice and data information between base station 28 and respective terminals 24. Communications link 32 can be implemented with networks using a variety of multiple access techniques, including TDMA, FDMA, CDMA, OFDM or hybrid systems such as GSM, etc. Furthermore, communications link 32 can transmit different channels multiplexed together.

In a present embodiment, data transmitted over communications link 32 is transmitted over a packet-based protocol such as TCP/IP. Other packet-based protocols will occur to those of skill in the art, and communications link 32 is operable to transmit different packet types as is appropriate. Communications link 32 can also include support for various Quality-of-Service standards (QoS), such as RSVP. Other QoS standards and-protocols will occur to-those of skill in the art.

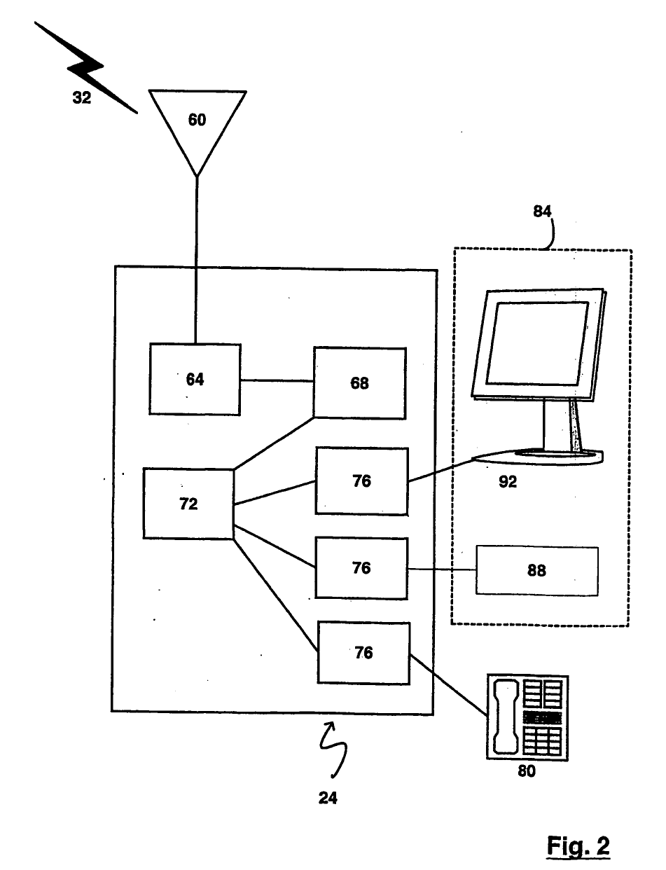

Referring now to FIG. 2, an embodiment of a POS terminal 24 for a retail environment is shown in greater detail. POS terminal 24 comprises an antenna 60, or antennas, for receiving and transmitting radio-communications over communications link 32. In turn, antenna 60 is connected to a radio 64 and a modem 68, which in turn is connected to a microprocessor-assembly 72. Microprocessor-assembly 72 can include, for example, a StrongARM processor manufactured by Intel, that performs a variety of functions, including implementing A/D-D/A conversion, filters, encoders, decoders, data compressors, de-compressors and/or packet disassembly.

As seen in FIG. 2, microprocessor-assembly 72 interconnects modem 68 and one or more ports 76, for connecting POS terminal 24 to one or more telephony devices 80 and one or more data devices 84. An example of a telephony device 80 would be a telephone handset, speaker phone or the like, which is operable to receive voice received over communications link 32. Examples of a data devices 84 include personal computers, bar code readers, magnetic card swipe readers, cash registers, receipt printers and keyboards. Other data devices 84 will occur to those of skill in the art. At least one data device 84 is an authentication device 88, typically a card swipe reader and is operable to collect a customer identifier as to determine the account 26 to be charged. At least one other data device is display device 92. Display device 92 is operable to display relevant information, including the amount of the purchase and to indicate whether or not the transaction is approved. The hardware used for display device 92 is not particularly limited and can include LCD and CRT monitors. Other types of display device 92 are within the scope of the invention.

Microprocessor-assembly 72 is operable to process data between ports 76 and modem 68. In the embodiment shown in FIG. 2, POS terminal 24 is attached to a combined cash register and display device 92 and a telephone. However, integrated units that combine all the above-described functionality in a single casing are also within the scope of the invention.

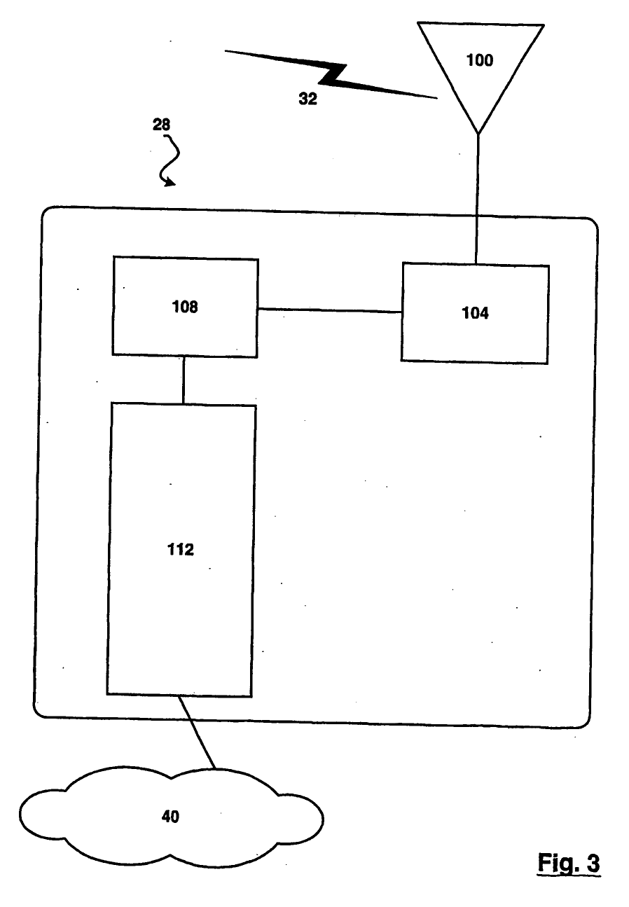

Referring now to FIG. 3, an example of base station 28 is shown in greater detail. Base station 28 comprises an antenna 100, for receiving and transmitting radio-communications over communications link 32. In turn, antenna 100 is connected to a radio 104 and a modem 108. Modem 108 is connected to a microproessor-router assembly 112 such as a Pentium III™ processor system manufactured by Intel. It will be understood that microprocessor-router assembly 112 can include multiple microprocessors, as desired and/or that the router can be provided as a separate unit if desired. The router within microprocessor-router assembly 112 is connected to a backhaul 40 in any suitable manner, which in tun connects base station 28 to financial network 36, retailer systems 44 and third-party systems 46. Base station 40 can be connected to backhaul 40 by a link such as T1, T3, E1, E3, OC3 or other suitable land line link, or can be a satellite or other radio or microwave channel link or any other link suitable for operation as a backhaul 40 as will occur to those of skill in the art.

Within financial transaction system 20, network services such as transaction processing and telephony call processing are all software applications. Software plug-ins are loaded into the network dynamically, on demand, as part of the transaction process. Dynamically loaded software plug-ins can perform their particular, specialized function on the data stream. For example, software can specialize in voice coding or decoding, encryption, digital signing and/or verifying, logging, filtering, mixing, 1P traffic shaping, IP traffic policing, or IP content filtering, etc. Other software plug-ins will occur to those of skill in the art. Individual POS terminals 24 can be dynamically configured based on customer, retailer, transaction amount, and so on—on a transaction by transaction basis.

Distributed through financial transaction system 20 are a number of software ‘agents’, which negotiate the rules and behaviors of the financial transaction. The software architecture used in financial transaction system 20 is distributed so that software agents can operate on different hardware components of the network such as base stations 28, POS terminals 24 (as shown in FIG. 2), or financial services provider 36, wherever computational and bandwidth resources are available. A method of determining computational and bandwidth resources is discussed in Canadian Patent Application 2,300,453, the contents of which arm hereby incorporated by reference. Other methods of determining computational and bandwidth resources will occur to those of skill in the art. Preferably, all the software agents will be present on the same hardware component during the transaction in order to save time and bandwidth, but this is not a requirement of the invention and software agents can intercommunicate and operate through backhaul 40 or other parts of system 20.

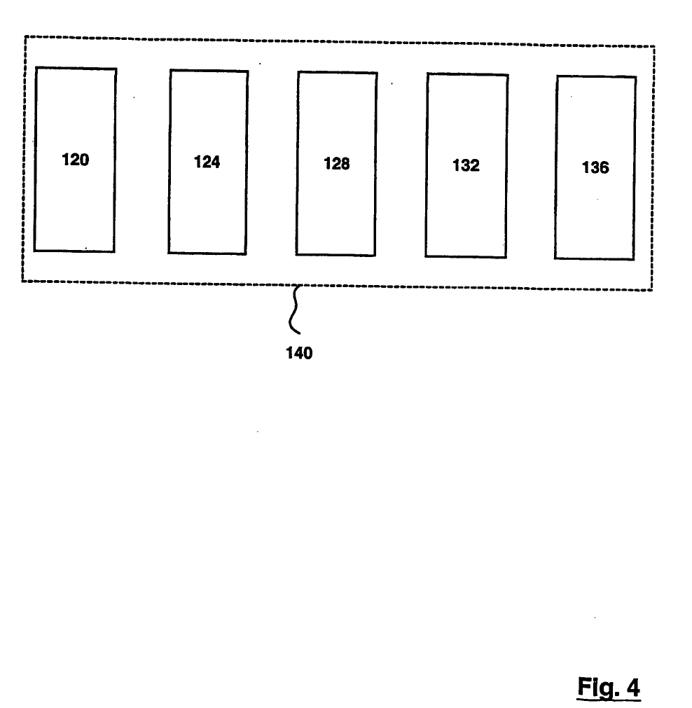

In FIG. 4, a typical set of particular software agents is shown. In general, a plurality of the following software agents will typically be involved in a transaction: a customer agent 120, a retailer agent 124, a financial services agent 128, a merchandise agent 132, and one or more third-party agents 136. Another agent, negotiation manager 140 may also be present to facilitate the negotiations between the other software agents. Other software agents will occur to those of skill in the art. It is contemplated that not all these software agents need be present in every transaction, especially if one or more entities are not involved in the transaction. For example, no third parties may be involved, so no third party agents 136 will be involved.

In the present embodiment, agents and their behaviors are expressed in Java code. Other suitable coding languages, such as C++ are within the scope of the invention and other suitable coding languages will occur to those of skill in the art.

Information is exchanged between different agents, as needed, using any suitable format such as XML or tab-delimited ASCII text. Other methods of exchanging information between agents will occur to those of skill in the art.

In the present embodiment of the invention, software agents are instantiated created as needed, based upon data records which can be stored throughout financial transaction system 20. Customer agents 120 are created from the data in customer agents records; retailer agents 124 are c ed from the data in retailer agents records; financial services agents 128 are created from the data in financial services records; merchandise agents 132 are created from the data in merchandise agents records; third-party agents 136 are created from the data in third-patty records; and negotiation managers 124 are created from negotiation manager schema or records. Other agent-creating records that are needed for other agents are also within the scope of the invention.

As the software architecture in financial transaction system 20 is distributed, the creation of software agents is independent of any particular hardware component. For example, while customer agents 120 could typically be located at a credit card company's central server within financial services provider 36, during a period of heavy network traffic, customer agents 120 can be created on base station 28, or on POS terminal 24. Alternatively, instead of creating software agents as needed, frequently used software agents can remain in memory within system 20 for extended periods of time.

The rules and behaviors employed and determined by the software agents in system 20 can vary widely. In general, a rule is a required element of the transaction and a behavior is a desired element Examples of rules include the authentication and security processes used in a credit card transaction, such as requiring a customer signature for a credit card purchase is a rule, as is requiring a PIN number for a debit card purchase. Requiring an authorization check for a purchase is a rule. Failing to enact these rules or failing to satisfy the conditions of the rules results in the transaction being cancelled. Examples of behaviors would be asking the customer if he or she collects air-miles or other loyalty points, or if he or she would like to be put on a store's mailing list. Generally, when a behavior is not satisfied, the transaction can still proceed.

Customer agents 120 represent the customized rules and behaviors of the customer making a purchase, typically via a credit or debit card. Typically, a customer agent record for customer agent 120 is stored with financial services provider 36 and is accessed when the account 26 number being used for the purchase is received by financial services provider 36. Alternatively, the customer agent record can be stored with credit identifier 22, provided credit identifier 22 posses suitable storage capacity, such as on a smart card. Other storage locations for customer agent record are within the scope of the invention.

It is contemplated that customers can set some of their own customer agent 120's rules and behaviors from a web-page hosted by the credit-card company or banking institution or via an IVR system which will then be incorporated into the customer record. For example, a customer can specify that they never wish to placed on mailing lists. The rules and behaviors that can be negotiated and implemented by customer agent 120 are not particularly limited. Examples of rules and behaviors implemented by customer agent 120 can include:

(i) adjusting the account's credit or purchase limits (within the restrictions set by financial service provider 36);

(ii) setting privacy preferences allowing the customer to automatically opt in or out of providing personal information to the retailer,

(iii) directing payments of small percentages to specified third parties, such as registered charities, etc.;

(iv) setting scalable authorization requirements depending on the amount of purchase, such as requirement of a PIN or other special method of authentication (electronic capture of signature, or biometric security devices such as collecting thumbprints, handprints, voiceprints, retinal scans, etc.);

(v) providing a visual image of the customer for authentication, this image being stored on credit identifier 22 or downloadable from a database within financial services provider 36. This image would appear in display device 92 of the POS terminal 24 used by the retailer staff. Alternatively, this portrait might be only accessed when there is suspected fraudulent use or a given purchase amount will be exceeded;

(vi) allowing multiple users to use account 26 using the same or different client identifiers 22, each with different levels of access, such as allowing the customer's children to use credit identifier 22 but requiring parental authorization over the phone;

(vii) creating restrictions on which retailers credit identifier 22 can be used with: (i.e., the account 26 owner can create a list of retailers authorized to accept the card). For example, an individual could provide-his or her children with a ‘gas’ card, a credit card that could only be used at major gas stations;

(viii) determining transaction record formats such as administration of purchase expenses by category (personal/business, travel, entertainment, etc.) with generation and e-mail of receipts in a preferred format; or

(ix) expression of purchase prices in a home currency, rather than the currency the price was expressed in by the retailer. In this case, the appropriate exchange rate that the transaction will be completed at can be used to perform the conversion, allowing the customer to authorize an exact amount in the home currency.

Other rules and behaviors for client agent 120 will occur to those of skill in the art. The options for rules and behaviors available for customer agents are determined by the financial services provider that provides account 26, allowing the financial services provider to provide differentiated services.

Retailer agent 124 represents the customized rules and behaviors of the retailer involved the transaction. Retailer agent 124 typically resides within the POS terminal 24, and is automatically created at the beginning of the transaction based upon a retailer agent record stored within POS terminal 24 or made available form elsewhere by the retailer. The rules and behaviors that can be negotiated and implemented by retailer agent 124 are not particularly limited and can include:

(i) updating and querying connected inoperable databases within retailer systems 44 such as ERP databases, customer information or customer loyalty databases;

(ii) displaying a set of script cues for the retailer to be displayed on display device 92 of POS terminal 24 (“Congratulations! It's your hundredth purchase from us, and it's feel!”, “Would you like our extended warranty?”, etc.;

(iii) customizing telephone service on telephony device 80 at the POS terminal 24, with custom dialing features (local only, headquarters only, intercom modes, call-in restricted to supervisor, etc.);

(iv) monitoring of an individual check out clerk throughput or behavior (if a microphone, web cam or telephone handset is a device 84 at terminal 24, for example)

(v) automatically extending credit limits for loyalty members, perhaps in financial partnership with credit card issuers or the like;

(vi) customized authorization levels, based upon the amount of purchase, individual customer history, and card type. For example, gold-card users can automatically be approved of all transactions less than $1000. Authorization could require signature, visual identification, biometric security, etc.;

(vii) storing and then process a number of transactions all at once. Such a service would be valuable when dealing with high volumes of customers and a low risk for declined cards, such as at a concession stand in a sports stadium;

(viii) gathering personal information about the customers; and

(ix) ensuring that account 26 has sufficient funds or credit to enact the purchase.

Other rules and behaviors for retailer agent 124 will occur to those of skill in the art. Retailers, in conjunction with financial services providers will be able to develop custom rules and options for their POS terminals 24.

Financial services agents 128 represent the customized rules and behaviors of the financial services provider (i.e., the credit/debit card company). Financial services agents 128 are created from financial services records, typically stored at financial services provider 36's central servers and databases, but can be loaded into base station 28 or POS terminals 24. The rules and behaviors that can be negotiated and implemented by financial services agent 128 are not particularly limited and can include:

(i) automatically reconciling customer and retailer accounts;

(ii) updating and querying loyalty-card databases;

(iii) customized security levels, based upon the amount of purchase, individual customer history, geographical location and card type. For example, a store in an area known for a high level of fraudulent activity could require a higher level of security than one in an area with lower levels of fraud. Another example would be a request to authorize a $1000 purchase in made from a Paris shop for a North American customer without a history of traveling to Europe. Based upon these circumstances, the credit card company requires a higher level of security to authorize the transaction.

(iv) ensuring sufficient funds or credit in account 26 for the purchase; and

(v) alerting retailer agent 124 or appropriate third-party agent 136 (such as the police) about a suspicious purchasing pattern occurring on account 26.

Other rules and behaviors for financial services agent 128 will occur to those of skill in the art. Each financial services provider 36 can develop their own rules and behaviors.

Merchandise agents 132 represent the customized rules and behaviors of the company which produces the product or service being purchased. Merchandise agents 132 are created from merchandise agent records that can reside within financial services provider 36, base station 28, POS terminal 24, or a central server within third-party systems 44. The rules and behaviors that can be negotiated and implemented by merchandise agent 132 are not particularly limited and can include:

(i) providing instant customer rebates;

(ii) extended warranties for the purchaser when using the credit card;

(iii) extra frequent flyer or other loyalty points, or the like;

(iv) other-special offers made in conjunction with the credit card company, retailer or customer (e.g., “Buy 2 XYZ products this month and get the third one at 50% off”).

Other merchandise agents 132 will occur to those of skill in the art and can be crafted by each merchandiser and/or changed at any time, as desired.

Third-party agents 136 represent the customized rules and behaviors of relevant third parties that have an interest in the transaction taking place. Examples of interested third parties include the police, the Better Business Bureau, credit rating agencies, trust service agencies, etc. Third-party agents 136 are created from third-party agent records that typically reside within third-party system 44, and are typically requested by another agent participating in the negotiation. The rules and behaviors that can be negotiated and implemented by third-party agents 136 are not particularly limited and can include:

(i) updating and querying connected interoperable databases within third-party systems 44, such as ERP databases, customer information or customer loyalty databases; and

(ii) providing information about one party involved in the transaction to another.

Other rules and behaviors for third-party agents 136 will occur to those of skill in the art.

Negotiation Manager 140 is operable to manage the negotiation of rules and behaviors for the transaction. The negotiation manager record can be stored on any suitable hardware within financial transaction system 20. Correspondingly, the negotiation of rules and behaviors between software agents can occur on any suitable hardware within financial transaction system 20, although generally for load-balancing reasons it is preferable to distribute these negotiations to either base stations 28 or POS terminals 24. Preferably, negotiation manager 140 is operable to:

(i) identify all software agents participating in a negotiation;

(ii) organize the rules and behaviors to be negotiated into successful negotiation stages;

(iii) implement a negotiation discipline which allows each participating software agent to consider a rule or behavior and either accept the rule or behavior or amend the values of the rule or behavior, and do so in a trusted environment;

(iv) respond to the negotiation being successful in a stage by proceeding to next stage or by completing the transaction if all stages have been successfully negotiated;

(v) identify loops, cycles and other anomalies in the negotiations;

(vi) determine whether the negotiation will be successful;

(vii) return audits to the participants identifying the values of rule or behavior that were modified, and by whom, from stage to stage;

(viii) detect whether an agent has violated a rule of the negotiation;

(ix) ensure termination within a limited number of stages if the negotiation has not achieved success; and

(x) provide forensic information to participants if the negotiation terminates without convergence.

Other capabilities of negotiation manager 140 will occur to those of skill in the art.

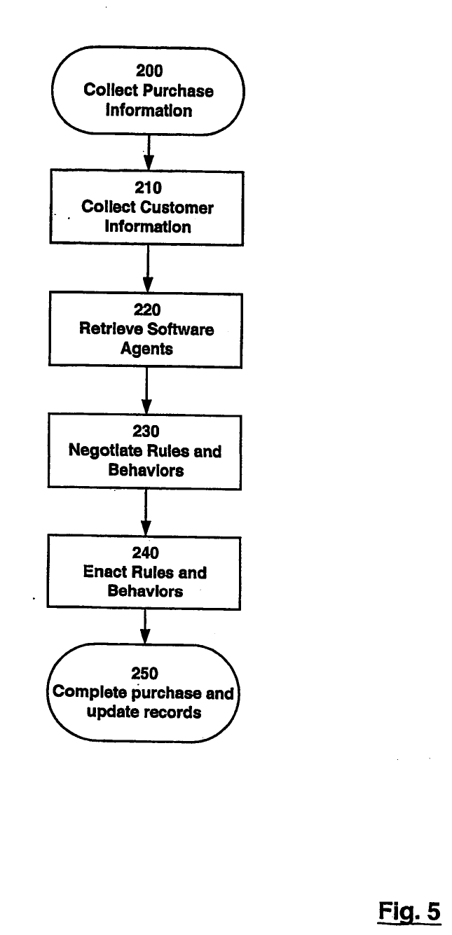

Referring now to FIG. 5, a flowchart of a method for completing a purchase is shown. Beginning at step 200, purchase information is collected. Purchase information includes the purchase amount, but can also include identification of the items being purchased and other related information. The method of gathering purchase information is not particularly limited and can include using different attached data devices 84 to gather information, such as a barcode reader or keyboard input. Other methods of gathering purchase information will occur to those of skill in the art.

Once the purchase information has been gathered, the method advances to step 210 where customer information is collected at POS terminal 24 from credit identifier 22. Customer information includes the payment type (such as credit charge, debit charge, etc) and account 26 being charged. The method of collecting customer information is not particularly limited and can include different information gathering means such as collecting account 26 information from credit identifier 22 using an attached data device 84 such as a magnetic card reader or keyboard input. Other means of gathering customer information will occur to those of skill in the art.

Once the customer information has been gathered, the method advances to step 220 where the software agents to be used in the negotiations are retrieved. These agents can include customer agent 120, retailer agent 124, financial services agents 128, merchandise agents 132, third-party agents 136 and negotiation manager 140. Not all these agents need to be retrieved in order to proceed.

Once the software agents have been retrieved, the method advances to step 230 where the software agents negotiate the rules and behaviors of the transaction. Methods of determining negotiations are described in more detail below.

Once the negotiations are complete, the method advances to step 240 where the rules and behaviors successfully negotiated are enacted. The rules and behaviors that can be enacted are not particularly limited, nor are the methods of implementing these rules and behaviors. For example, a typical rule would be that the account 26 being charged has sufficient funds or credit to enable the purchase. Financial services provider 36 would then check its account 26 records to confirm that this was true, and financial services agent 128 would report the outcome of that query.

The enactment of many of the agreed-upon rules and behaviors by the software agents can be invisible to the customer and the sales representative. For example, a customer goes into an electronics shop and purchases a video game console with a preferred credit card. Because the customer used the preferred credit card, he or she gets an instant discount in the price. The manufacturer of the console gives the retail shop a credit to reimburse it for the lower sale price. This sequence of events is the result of negotiations between retailer agent 124, financial services agent 128, and merchandise agent 132.

Once these rules and behaviors have been enacted and their conditions satisfied, the method advances to step 250 where the purchase is completed and all relevant records are updated and account 26 is charged appropriately and all other accounts are updated accordingly.

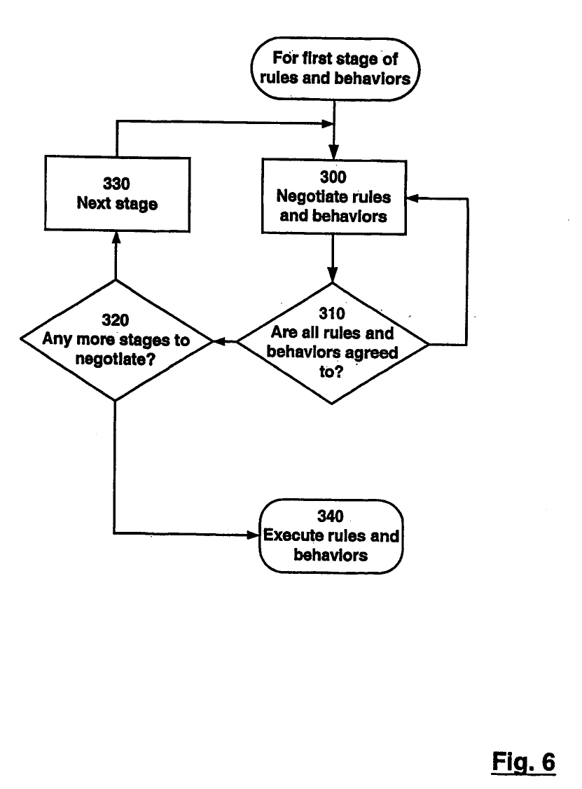

Referring now to FIG. 6, a flowchart of a method for handling the negotiation of rules and behaviors in accordance with an aspect of the present invention is shown. As will be discussed in more detail below, negotiation between software agents preferably occurs in stages, each stage having a subset of the set of rules and behaviors to be negotiated, although it is also contemplated that negotiations can be performed in a single stage. The process commences with the first stage wherein values for one or more rule and/or behavior are negotiated between the software agents representing the entities in the transaction at step 300. A determination is made at step 310 as to whether values for all rule and/or behavior being negotiated in that stage have been agreed to by the entities. If the values have not been agreed, the negotiation in step 300 repeats. If values have been agreed for all rules and/or behaviors of a stage, a determination is made at step 320 as to whether any more stages exist to be negotiated. If one or more stages do exist to still be negotiated, at step 330 the next stage is selected and the negotiation of step 300 is performed for the rule and/or behavior of that stage. If at step 320 it is determined that no more stages exist to be negotiated, the process proceeds to step 340 where the desired negotiation is complete, so that the various entities of financial transaction system 20 can enact the agreed upon rules and behaviors

The present invention preferably separates negotiation of a transaction into stages, where values for smaller sets of rule and/or behavior are negotiated at the different, successive stages so that progress towards agreement is logical and steady. This can reduce the level of complexity at each stage, so that there are fewer tradeoffs and alternatives to be considered during negotiation, and analysis of negotiations which failed or which produced undesirable results, are easier to perform.

The invention provides for the “categorization of concerns” of rules and behaviors, in that some rules can be more important to overall success (“deal breakers”) and/or some rules and behaviors are dependent upon others. It does not make sense to negotiate less important behaviors if one or more deal breaker rules cannot be agreed upon. For example, an transaction may require a guaranteed minimum level of authentication security, and if such security cannot be provided, then there is no sense in attempting to continue. Similarly, it does not make sense to negotiate a rule or behavior whose relevance or meaning depends from another rule or behavior before that other term has been agree. So, the parameters whose values are to be negotiated are arranged in a multilevel hierarchy, each level being negotiated as a stage. In practice, however, it is contemplated that a financial services provider would provide a; programming framework for determining customer agents 120 and retailer agents 124 so that impasses would be uncommon.

This invention conceives of the negotiation of security as one of scalable requirements, with different levels determined by customer agents 120, retailer agents 124 and financial services agents 128. When these levels differ, generally, the most secure level will be chosen. Other methods of resolving impasses are discussed in CDN patent application 2,300,453, discussed above.

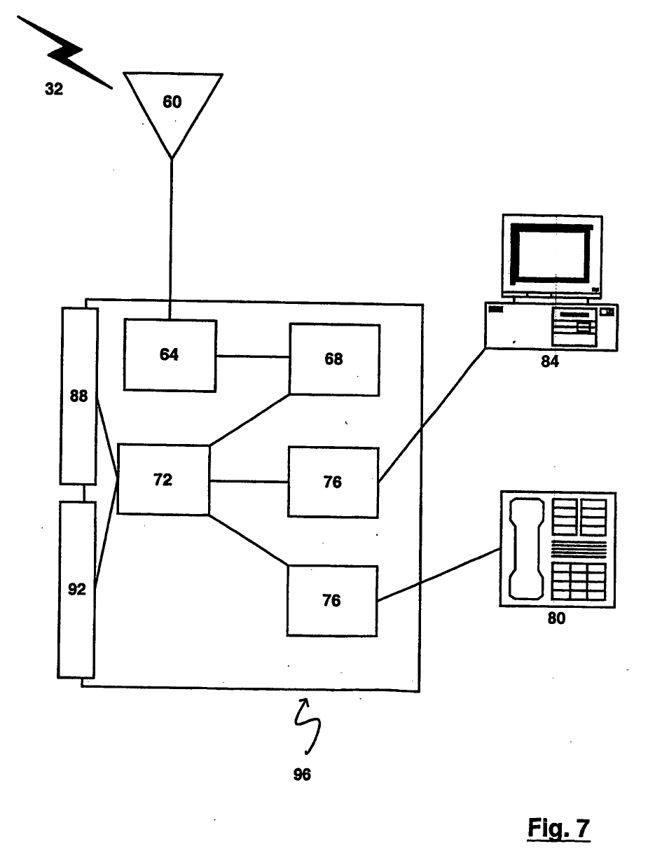

While the above-described POS terminal 24 is contemplated for retail use, it is also contemplated that a POS terminal can reside at a customer's residence or, if a wireless device, with the customer as a portable device such as a personal digital assistant, etc. in order to enable and enhance online and/or telephone shopping. Referring now to FIG. 7, another embodiment of the invention, residential POS terminal 96, is shown in greater detail. Residential POS terminal 96 is operable to transmit data and telephony information to and from a base station 28 and data and telephony devices attached to residential POS terminal 96. Additionally, residential POS terminal 96 is operable to transit and receive purchase information directly to and from base station 28, bypassing any attached data and telephony devices.

Residential POS terminal 96 comprises an antenna 60, or antennas, for receiving and transmitting radio communications over communications link 32. In tun, antenna 60 is connected to a radio 64 and a modem 68, which in turn is connected to a microprocessor-assembly 72. Microprocessor-assembly 72 can include, for example, a StrongARM processor manufactured by Intel, that performs a variety of functions, including implementing A/D-D/A conversion, filters, encoders, decoders, data compressors, de-compressors and/or packet disassembly.

As seen in FIG. 7, microproessor-assembly 72 interconnects modem 68 and one or more ports 76, for connecting residential POS terminal 96 to one or more telephony devices 80 and one or more data devices 84. An example of a telephony device 80 would be a telephone, or the like, which is operable to receive voice received over communications link 32. Examples of a data devices 84 include personal computers and facsimile machines. Other data devices will occur to those of skill in the art Accordingly, microprocessor-assembly 72 is operable to process data between ports 76 and modem 68.

Also attached to microprocessor-assembly 72 is an authentication device 88 and a display device 92, either or both of which can be implemented in a data device 84, such as an appropriately equipped personal computer, personal digital assistant, etc. Authentication device 88 is operable to retrieve account 26 information from credit identifier 22 and to authorize purchases. The means of retrieving account 26 information from a credit identifier 22 are not particularly limited and can include a magnetic strip card reader, an optical device, an electronic sensor, a touchpad or a keypad. Other means of retrieving account 26 information from credit identifier 22 will occur to those of skill in the art. The means of authorizing purchases are not particularly limited and can include an implicit authorization based on swiping the credit or debit card, entering a PIN number or password into a keypad, or providing an electronic signature using a touch pad.

Display device 92 is operable to display messages. These messages can include instructions on how to use residential POS terminal 96, purchase amounts, authorization requests, account balances and confirmations of successful transactions. Other messages displayable by display device 92 will occur to those of skill in the art. In the present embodiment, display device 92 is an LCD panel. However, other types of display device 92 are within the scope of the invention.

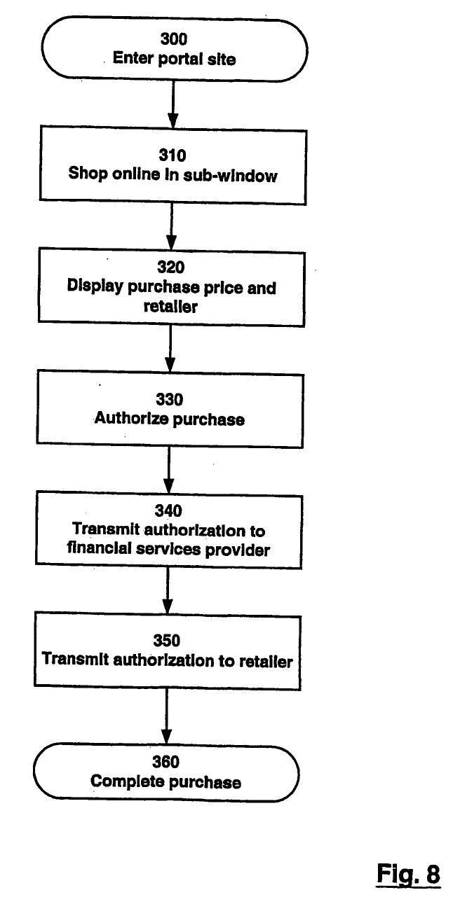

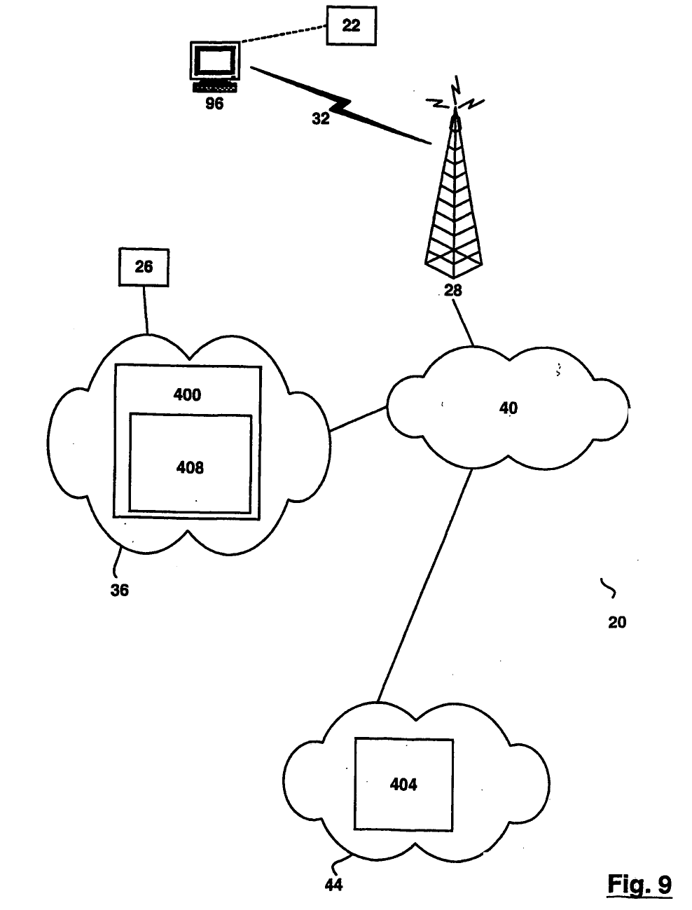

In another embodiment of the invention, a flow-chart of a method for shopping online from a residence or other remote location is shown in FIG. 8. References will also be made to FIG. 9, which shows a system layout of the method described in FIG. 9.

Beginning at step 300, the customer uses an Internet-capable data device 84 such as a home computer that is attached to residential POS terminal 96 to visit a portal website 132 controlled by financial services provider 36. Other Internet-capable data devices 84 such as PDAs or web enabled televisions are also within the scope of the invention.

In this example, the access to the Internet is provided through POS terminal 96 via communications link 32, base station 28 and backhaul 40. It is also contemplated that in other circumstances, Internet access for data device 84 can be provided through a separate service, such as a DSL modem, etc.

The customer logs into financial portal website 132, preferably using his or her credit identifier 22 with authentication device 88. Alternatively, the customer could login by entering a password for an account 26 on an online form. Once the customer has successfully logged into financial portal website 400, communication between financial portal website 400 and the customer on data device 84 is done using a secure application and transport protocols such as HTTPS and SSL.

At step 310, from the financial portal website 400, the customer can then travel to different e-commerce web sites 404 retrieved from retailer systems 44 and displayed within a sub-window 408 generated by financial portal website 400. Within sub-window 408, the customer browses and shops online normally.

As is known to those of skill in the art, online shopping typically involves a customer selecting items (often referred to as placing the items in your “shopping care”) for purchase and then purchasing all the selected items at once (proceeding to the “checkout”).

At step 320, the retailer's name and the purchase price are displayed on display device 92 of residential POS terminal 96. This information is provided by e-commerce web site 404 and retailer systems 44.

At step 330, to complete the transaction, the customer engages authentication device 88 with his or her credit identifier 22 (such as by swiping a credit card in the card read).

At step 340, authentication device 88 then transmits the authentication information across an encrypted secure channel to financial portal website 400, which then authorizes the transaction to the retailer by providing a one-time-use number to e-commerce web site 404 in sub-window 408. The retailer never sees the customer's real account 26 number. If software agents are being used to negotiate the transaction, then the negotiations occur (as discussed above) right before the transaction is processed.

At step 360, the purchase is completed. The results of the transaction are displayed on display device 92 as well as data device 84. Account 26 is charged appropriately and all relevant accounts are updated accordingly.

While the embodiments discussed herein are directed specific implementations of the invention, it will be understood that combinations, sub-sets and variations of the embodiments are within the scope of the invention. For example, it is contemplated that the POS terminal 24 may be connected to base station 28 using a cable or DSL modem in lieu of a wireless radio modem.

It is contemplated that telephony devices 80 and data devices 84 used in POS terminal 24 could be fully integrated into a single hardware device.

It is contemplated that, leveraging telephony device 80, POS terminal 24 could provide a voice connection to be established between POS terminal 24 and an Authorization center within financial services provider 36, rather than just declining the transaction and asking that the retailer representative call the authorization center (which they are often reluctant to do). With a built-in telephony device 80, the authorization process can be expedited.

It is contemplated that using an appropriate data device 84, POS terminal 24 can provide other authentication means such as using voice prints, biometric, smart card and or visual images of account 26 owner.

It is contemplated that display device 92 could display a visual image of account 26's owner. The visual image could be provided by credit identifier 22 or from a database within financial services provider 36—downloading a picture for visual recognition. Additionally, if one of the attached data devices 84 is a web camera, POS terminal 24 could upload pictures of the customer to a central registry within financial services provider 36 for future use. Alternatively, the retailer could maintain a database of visual records for their own security.

It is contemplated that POS terminals 24, not requiring a telephone line connection, could be deployed anywhere in the retailer's store and be operable to ‘auto-provision’ itself. Configuring POS terminals 24 could be as simple as turning the device on. POS terminals 24 would automatically acquire base station 28 and download the appropriate files. Base station 28 would automatically allocate appropriate resources to support POS terminal 24.

It is further contemplated that the portability and rapid deployment of POS terminals 24 provides for new possibilities. POS terminals 24 could be moved throughout the store to take advantage of sales in particular departments. During peak sales seasons such as Christmas, the store could deploy additional POS terminals 24. The rapid deployment of the device would make POS terminals 24 suitable for being rented by financial services provider 36 or others, so that the retailer would not have to own excess units. Such POS terminals 24 would also be of use for special events such as outdoor concerts.

It is contemplated that customer agents 120 could be stored within the memory of credit identifier 22 using ‘smart card’ technology. As known to those of skill in the art, smart cards provide superior data storage capacities to conventional magnetic card strips. Storing customer agents 120 within a smart card would reduce the bandwidth and server load requirements of financial transaction system 20. Additionally, storing customer agent 120 within the smart card would ensure that customer agent 120 would always be available to the customer regardless of the status of financial transaction system 20. Since the customer would likely update his or her customer preferences on a web page or by telephone, there is the possibility that different versions of customer agent 20 would exist on system 20. To prevent version conflicts, financial server provider 36 could download new versions of customer agent 120 to credit identifier 22 during the authorization process.

It is further contemplated that utilizing the distributed capabilities of the operating system, software agents and transaction negotiations could be pushed to the ‘edges’ of the financial transaction system 20. Rather than relying upon a central authorization services within financial services provider 36, customer information could be cached at base stations 28. This way, if the network was congested or unavailable, then the decision to approve or decline customers can be made automatically.

Even if communications link 32 between POS terminals 24 and base station 28 failed, financial services agents 128 could be available in POS terminal 24, so that transactions could still occur. POS terminal 24 would store the transaction records until communications link 32 was restored.

It is further contemplated that, with a barcode reader and a monitor/touchscreen attached as data devices 84, POS terminal 24 could serve as a self-serve kiosk. Leveraging the broadband capabilities of modem 64, POS terminal 24 could access HTML pages such as a catalog or schedule information.

Alternatively, POS terminal 24 could be connected/installed in a vending machine. For example, a POS terminal 24 in a commuter train station could sell individual tickets and monthly passes. The network connectivity allows the screen to display up-to-date schedule information, so that the commuters could order specific tickets.

A POS terminal 24 could be connected to a newspaper vending machine. The price changes according to the time of day, so that the paper is $1 in the morning, $0.50 in the afternoon, and free after 7:00. Dynamic pricing is useful for a wide range of time-sensitive products such as airline and concert tickets. Since POS terminal 24 is remotely linked to a central server, then prices could be adjusted at the vendor's discretion.

It is further contemplated that financial transaction system 20 could use small ‘micro’ base stations 28 that operate at a lower power level and function within the retailer's premise. A micro base station could also use an unlicensed spectrum band.

It is contemplated that should that, during the negotiation phase, the software agents reach an impasse, then they could ‘appeal’ to the person or organization that they resent, such as an employee of the financial services agency for financial services agent 128, an employee of the retailer for retail agent 108, and the customer making the purchase for customer agent 120. These individuals could temporarily override the rules and behaviors of their respective software agent. For example, a customer has a rule that a signature is always required for a credit card purchase. However, at this time the receipt printer attached to the POS terminal 24 is broken and a signature cannot be taken and recorded. The customer agrees to override this rule and instead provides an alternate security mechanism (such as providing a PIN number or password).

It is further contemplated that software agents used do not have to be software programs but could be simply data that is acted on by negotiation manager 408.

It is further contemplated that software agents used in the program need not distributed but can run at specific points within financial transaction system 20.

The examples given above all assume credit or debit card use. However, other suitable monetary transaction methods such as cash cards, micropayment schemes, virtual currencies (such as PayPal), etc are within the scope of the invention.

The above-described embodiments of the invention are intended to be examples of the present invention and alterations and modifications may be effected thereto, by those of skill in the art, without departing from the scope of the invention which is defined solely by the claims appended hereto.

We claim:

1. A financial transaction system operable to manage purchases of at least one of goods and services, comprising:
a customer identifier operable to uniquely identify an account to which said purchases of at least one of goods and services are being charged;
a financial services provider operable to provide and maintain at least one of a debit and credit account to which the purchases are being charged;
a plurality of point-of-sale terminals in communication with said financial services provider via an intermediary node, where said point of sale terminals are operable to collect purchase information, customer account information and authorization information, and where said point-of-sale terminal is operable to display messages provided from said financial services provider, and
a plurality of software agents distributed within the financial transaction system, each software agent operable to negotiate rules and behaviors for the purchase of goods and services.

2. The financial transaction system of claim 1 where said software agents includes a customer agent which represents the interests of a customer purchasing said goods and services when negotiating rules and behaviors for said purchase of at least one of goods and services.

3. The financial transaction system of claim 2, where said customer agent negotiates rules and behaviors regarding distributing personal information about said customer purchasing said at least one of goods and services.

4. The financial transaction system of claim 2, where said customer agent negotiates rules and behaviors towards directing a portion of a purchase amount for said at least one of goods and services towards a third party.

5. The financial transaction system of claim 2, where said customer agent negotiates rules and behaviors regarding said customer's authorization requirements for said purchase of at least one of goods and services.

6. The financial transaction system of claim 5, where said customer's authorization requirements include determining who is authorized to make said purchase of at least one of goods and services.

7. The financial transaction system of claim 5, where said customer's authorization requirements include mining which retailers said purchase of at least one of goods and services can be made from.

8. The financial transaction system of claim 5, where said customer's authorization requirements include providing a visual image of said customer to a retailer selling said at least one of goods and services.

9. The financial transaction system of claim 5, where said customer's authorization requirements include the gathering of said customer's signature.

10. The financial transaction system of claim 5, where said customer's authorization requirements include the gathering of biometric information.

11. The financial transaction system of claim 5, where said customer's authorization requirements include a vocal confirmation authorizing said purchase of goods and services.

12. The financial transaction system of claim 2, where said customer agent negotiates rules and behaviors for generating records of said at least one of goods and services purchased.

13. The financial transaction system of claim 12, where said records of said at least one of goods and services purchased are electronically transferred to an e-mail address provided by said customer.

14. The financial transaction system of claim 1 where said financial network includes a retailer agent which represents the interests of a retailer selling said at least one of goods and services when negotiating rules and behaviors for said purchase of goods and services.

15. The financial transaction system of claim 14, where said retailer agent negotiates rules and behaviors regarding interactions with connected interoperable databases.

16. The financial transaction system of claim 14, where said retailer agent negotiates; rules and behaviors for generating records of said at least one of goods and services purchased.

17. The financial transaction system of claim 14, where said retailer agent negotiates rules and behaviors regarding displays of script cues for said retailer's employees.

18. The financial transaction system of claim 14, where said customer agent negotiates riles and behaviors regarding said retailer's authorization requirements for said purchase of at least one of goods and services.

19. The financial transaction system of claim 18, where said retailer's authorization requirements include displaying a visual image of said customer to said retailer's employee selling said at least one of goods and services.

20. The financial transaction system of claim 18, where said retailer's authorization requirements include the gathering of said customer's signature.

21. The financial transaction system of claim 18, where said customer's authorization requirements include the gathering of biometric information.

22. The financial transaction system of claim 18, where said retailer agent negotiates rules and behaviors regarding said retailer's employee getting authorization for said purchase via a telephone connection.

23. The financial transaction system of claim 14, where said retailer agent negotiates rules and behaviors regarding the determination of at least one of credit limits and purchase limits for said customer making said purchase.

24. The-financial transaction system of claim 14, where said retailer agent monitors behavior of said retailer's employee handling said purchase.

25. The financial transaction system of claim 14, where said retailer agent negotiates rules and behaviors regarding collecting personal information about said customer purchasing said at least one of goods and services.

26. The financial transaction system of claim 1 where said financial network includes at least one financial services agent which represents the interests of said financial network when negotiating rules and behaviors for said purchase of at least one of goods and services.

27. The financial transaction system of claim 26, where said financial services agent negotiates rules and behaviors regarding interaction with related databases.

28. The financial transaction system of claim 26, where said financial services agent negotiates rules and behaviors for generating records of said at least one of goods and services purchased.

29. The financial transaction system of claim 26, where said financial services agent negotiates rules and behaviors regarding the determination of at least one of credit limits and purchase limits for said customer making said purchase.

30. The financial transaction system of claim 26, where said financial services agent negotiates rules and behaviors regarding authentication requirements for said purchase.

31. The financial transaction system of claim 30, where said authorization requirements include providing a visual image of said customer to said retailer's employee selling said at least one of goods and services.

32. The financial transaction system of claim 30, where said authorization requirements include the gathering of said customer's signature.

33. The financial transaction system of claim 30, where said authorization requirements include the gathering of biometric information.

34. The financial transaction system of claim 30, where said authorization requirements include requiring said retailer employee getting authorization for said purchase via a telephone connection.

35. The financial transaction system of claim 1 where said financial network includes a merchandise agent which represents the interests of at least one of a manufacturer of goods and a provider of services whose at least one of goods and services is being purchased by said customer when negotiating rules and behaviors for said purchase of at least one of goods and services.

36. The financial transaction system of claim 35, where said merchandise agent negotiates rules and behaviors regarding interaction with related databases.

37. The financial transaction system of claim 35, where said merchandise agent negotiates rules and behaviors regarding a price for said purchase.

38. The financial transaction system of claim 35, where said merchandise agent negotiates rules and behaviors regarding collecting personal information about said customer purchasing said at least one of goods and services.

39. The financial transaction system of claim 1 where said-software agents includes at least one third-party agent which represents the interests of at least one third party when negotiating rules and behaviors for said purchase of at least one of goods and services.

40. The financial transaction system of claim 1, where said plurality of point of sale terminals communicates with said intermediary node via a wireless protocol.

41. The financial transaction system of claim 40, where said wireless protocol uses COMA technology.

42. A point of sale terminal operable to manage sales of at least one of goods and services to a customer, where said customer uses a financial services provider in lieu of cash, comprising:
input means to collect purchase information for said sales of at least one of goods and services;
input means to collect customer account information from a customer identifier provided by said customer purchasing said at least one of goods and services;
communication means to transmit said purchase information and said customer account information to a financial services provider via an intermediary node and to receive messages and authorization from said financial services provider,
input means to collect authorization from said customer,
display means to display said messages and authorization from said financial services provider, and
processing means operable to negotiate any rules and behaviors for said sale of goods and services.

43. The point of sale terminal of claim 42, where said point of sale terminal is operable to provide a voice connection between a retail employee and said financial services provider.

44. The point of sale terminal of claim 42, where said input means to collect authorization from said customer includes means for gathering biometric information from said customer.

45. The point of sale terminal of claim 42, where said input means to collect authorization from said customer includes means for collecting a visual image of said customer for identification.

46. The point of sale terminal of claim 45, where said point of sale terminal includes means for transmitting said visual image of said customer to said financial services provider.

47. The point of sale terminal of claim 45, where said terminal includes display means for displaying an image of said customer.

48. The point of sale terminal of claim 45, where said visual image of said customer is provided by said financial services provider.

49. The point of sale terminal of claim 45, where said visual image of said customer is provided by a smart card issued to said customer by said financial services provider.

50. The point of sale final of claim 42, where said point of sale terminal is operable to authorize purchases independently of said financial services provider.

51. The point of sale terminal of claim 42, where said point of sale terminal is operable by said customer as a self-serve terminal.

52. The point of sale terminal of claim 51, where said point of sale terminal operable to operate disbursements from a vending machine.

53. The point of sale terminal of claim 52, where said point of sale terminal is operable to remotely receive dynamic pricing information for said vending machine.

54. The point of sale terminal of claim 42, where said point of sale terminal is operable to be nomadic.

55. The point of sale terminal of claim 42, where said point of sale terminal is operable to autoprovision said point of sale terminal with said network base station.

56. The point of sale terminal of claim 42, where said communications means include a radio modem.

57. The point of sale terminal of claim 42, where said communications means include a DSL modem.

58. The point of sale terminal of claim 42, where said communications means include a cable modem.

59. The point of sale terminal of claim 42, where said input means to gather purchase information include a bar-code scanner.

60. The point of sale terminal of claim 42, where said input means to gather custom account information include a card reader.

61. The point of sale terminal of claim 42, where said input means to collect authorization from said customer include biometric devices.

62. A method for managing a purchase of at least one of goods and services between a customer using a financial services provider in lieu of cash and a retailer comprising:
collecting information about said purchase of at least one of goods and services;
collecting information about customer making said purchase of at least one of goods and services from a customer identifier,
retrieving software agents for said purchase of at least one of goods and services;
negotiating rules and behaviors for said purchase of at least one of goods and services between said software agents;
enacting said rules and behaviors for said purchase of at least one of goods and services;
collecting authorizations from said customer, retailer and financial services provider for said purchase of at least one of goods and services;
completing said purchase of at least one of goods and services; and
generating records of said purchase of at least one of goods and services.

63. A point of sale terminal operable to enact a purchase of at least one of goods and services to a customer, involving a financial services provider, comprising:
input means to collect information of at least one of goods and services;
input means to collect customer account information from a customer identifier,
input means to collect authorization from said customer for said purchase of at least one of goods and services;
communication means to transmit said information to said financial services provider via an intermediary node,
communication means to receive information and purchase authorization from said financial services provider,
display means to display said purchase information; and
display means to display said authorization from said financial services provider.

64. The point of sale terminal of claim 64, where said communications means include a radio modem.

65. The point of sale terminal of claim 64, where said communications means include a DSL modem.

66. The point of sale terminal of claim 64, where said communications means include a cable modem.

67. The point of sale terminal of claim 64, where said input means to gather customer account information include a card reader.

68. A financial transaction system operable to manage purchases of at least one of goods and services online, comprising:
a retailer operable to sell said at least one of goods and services online;
a customer identifier operable to uniquely identify an account to which said purchase of at least one of goods and services is being charged;
a financial services provider operable to at least one of debit and credit said account to which said purchase of at least one of goods and services is being charged, and where said financial service providers provides a sure means of for purchasing at least one of goods and services;
a point-of-sale terminal in communication with said financial services provider via an intermediary node, where said point of sale terminal is operable to collect purchase information, customer account information and authorization information, and where said point-of-sale terminal is operable to display messages provided from said financial services provider.

69. The financial transaction system of claim 69, where said plurality of point of sale terminals communicates with said intermediary node via a wireless protocol.

70. The financial transaction system of claim 68, where said wireless protocol uses CDMA technology.

71. A method for enacting a purchase of at least one of goods and services online using a point of sale terminal and a financial services provider comprising:
entering a securc financial portal site hosted by said financial services provider,
shopping online at a retail web in a sub-window provided by said financial portal site;
receiving purchase information on said point of sale terminal;
displaying said information about said purchase on said point of sale terminal;
collecting an authorization of said purchase of at least one of goods and services on said point of sale terminal;
transmitting said authorization of said purchase of at least one of goods and services said financial portal site; and
transmitting an one-use authorization from said financial portal site to said retail web site.
